(19) United States
(12) Patent Application Publication
(10) Pub. No.: US 2009/0012652 A1
(43) Pub. Date: Jan. 8, 2009

(54) Duct heater control module

(76) Inventors: Mike Nicholson, Winnipeg (CA); Brant Gilley, Winnipeg (CA); Lyle Mustard, Winnipeg (CA); Johann Baetsen, Winnipeg (CA)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/108,730

(22) Filed: Apr. 24, 2008

Related U.S. Application Data
(60) Provisional application No. 60/947,782, filed on Jul. 3, 2007.

(51) Int. Cl. G05B 13/00

(52) U.S. Cl. 700/278

(57) ABSTRACT

A duct heater control module for controlling an electric duct heater in an air duct. The duct heater control module includes a microcontroller for receiving an air flow signal from an air flow sensor for controlling the electric duct heater in response thereto. The microcontroller controls short cycling of the current switching relays, determines the nature of the input signal from a thermostat, and drives a status display.

### CROSS REFERENCES TO RELATED APPLICATIONS

This application claims priority to U.S. Provisional Patent Application No. 60/947782, filed Jul. 3, 2007, which is incorporated herein by reference.

### FIELD OF THE INVENTION

This invention relates to a duct heater control module for an electric duct heater.

### BACKGROUND OF THE INVENTION

In an HVAC system, an electric duct heater is installed in an HVAC air duct in order to heat the air moving through the duct. The electric duct heater may be the primary heat source for the HVAC system or may function as an auxiliary or supplemental heat source. A conventional electric duct heater comprises an enclosure, one or more electric heating elements or coils, a fan, and a duct heater control module for controlling the fan and for connecting a source of electric current to and disconnecting the source of electric current from the heating elements. The conventional duct heater control module housed within an electrical box typically includes (1) one or more high current switching relays for connecting the source of electric current to and disconnecting the source of electric current from the heating elements, (2) an air flow sensor switch for sensing the air flow through the duct heater, (3) a fan interlock relay for assuring that the fan that produces the air flow through the duct is operating before the heating elements are energized, (4) an automatic safety relay to disable the heating elements in response to an alarm signal, (5) a manual reset safety relay for disabling the heating elements in response to a manual alarm signal, and (6) a 24 VAC fuse (low-voltage) connecting the controller (thermostat) to the duct heater control module. Each device within the electrical box (i.e. relays, air flow sensor switch, etc) must be separately wired and tested. Such separate wiring is time consuming and therefore increases the cost of production of the conventional electric duct heater.

Due to the highly competitive nature of the HVAC business, assembly and parts costs must be kept under control. Currently, a single production assembler requires between 3-4 hours to assemble a conventional electric duct heater. Essentially one person can only produce 2-3 conventional electric duct heaters per day. Most of the assembly time is spent wiring the controls in the electrical box of the duct heater control module.

### SUMMARY OF THE INVENTION

In order to reduce production costs, a printed circuit board (PCB) is used to interconnect several components within the electrical box of a duct heater control module. The PCB reduces the complex wiring and testing required for a conventional duct heater control module because with a PCB there are no wires to cut, strip, and terminate. Therefore, a PCB saves time and expense compared to a conventional hard wired duct heater control module.

Also with a PCB implemented duct heater control module, many problems in the field can be quickly resolved by dropping a new PCB into the duct heater control module, as opposed to a field technician changing out and rewiring components in the field. Further, such changing out and rewiring components is time consuming and dangerous if the safety devices in the electrical box of the conventional duct heater control module are not rewired correctly.

While the PCB implementation of the duct heater control module produces the anticipated benefits identified above, the miniaturization of the control circuitry using a PCB creates other technical issues that must be resolved in order to reap the benefits identified above for a duct heater control module utilizing a PCB.

One such technical issue involves sensing the air flow through the duct heater. To ensure safety, an air flow sensor switch is used to sense both static pressure and velocity pressure within the air duct. The static pressure and velocity pressure indicate air flow within the air duct that is needed to prevent the heating elements in the electric duct heater from reaching dangerously high temperatures. When the PCB is used to implement the duct heater control module, a miniature air flow sensor switch, suitable for mounting on the PCB, is used to sense the air flow within the air duct. Due to the small size of the diaphragm of the miniature air flow sensor switch, chattering (pulsing) of the diaphragm occurs due to turbulence in the air stream within the air duct. The diaphragm chattering in the miniature air flow sensor switch can cause the current switching relays, mounted on the PCB, to cycle rapidly. The rapid cycling of the PCB mounted current switching relays would result in lower life expectancy for the current switching relays. To solve this problem, a programmable interface controller or microcontroller with a custom firmware routine monitors the output of the air flow sensor switch. If the pulse count received from the air flow sensor switch is above a certain threshold, the microcontroller generates an air flow OK signal that inhibits the premature deactivation of the current switching relays. If air flow stops and no pulses are detected for a predetermined time, the microcontroller will deactivate the current switching relays thereby preventing current flow to the heating elements and unsafe operation.

Another technical issue relating to miniaturization using a PCB involves short cycling of the current switching relays that connect the high current source to the heating elements of the duct heater. Because the PCB mounted current switching relays are smaller than standard switching relays used for conventional duct heaters, a substantial amount of current and voltage is switched by the smaller current switching relays in a small space. This operation of the smaller current switching relays in a confined space creates gases and heat that reduce the life expectancy of the current switching relays. In order to overcome the problem of reduced life expectancy for the current switching relays, the microcontroller is programmed to include anti-short cycle delays. For example, if a bad signal or faulty connection causes the current switching relays to cycle (activate and deactivate) rapidly, the microcontroller will detect the rapid cycling and will impose a delay on the next activation of the switching relays. The microcontroller, however, provides a fast deactivation response when a circumstance arises that requires the deactivation of the current switching relays. For example, if the air flow sensor switch senses an interruption or substantial decrease in the air flow while current is connected to the heating coils, the microcontroller, in response to the air flow signal from the air flow sensor switch, will immediately deactivate the current switching relays to prevent an unsafe overheat condition. Therefore the current switching relays are deactivated immediately if needed, but there will be a delay before the current switching relays can activated after a rapid cycling event. This anti-short cycle programming in the microcontroller will increase the life expectancy of the current switching relays in the field.

A further aspect of the present invention involves the variety thermostatic controllers used with the duct heater control module. In order to operate the duct heater, a controller or thermostat senses the temperature in the space to be heated and calls for heat from the duct heater when the temperature drops below a set point. The thermostat then turns off the duct heater when the temperature rises above a set point. Many different types of controllers or thermostats are used to control the operation of the duct heater. While virtually all these third-party controllers or thermostats are low voltage, 24 VAC, the thermostat output signals from such thermostats are not all the same. For example a 24 VAC thermostat output signal can be either switched hot or switched common. Switched hot and switched common identify the thermostat output signal's protocol. Switched hot means that the current switching relays open (deactivated) when the 24 VAC thermostat output signal is hot (24 VAC). Common switch means that the current switching relays open (deactivated) when the 24 VAC thermostat output signal is common (0 VAC). Typically a duct heater control module must be wired to accept either a switched hot signal or switched common signal and then matched with the appropriate controller or thermostat. Sometimes the thermostat switching information is not available at the time the duct heater is ordered, or the thermostat switching information is supplied incorrectly. For example, if a duct heater control module is wired as a switched hot signal, and then a switched common thermostat is supplied, the duct heater will not work. To solve this problem, the present invention incorporates detection hardware and firmware in the microcontroller of the duct heater control module that detects whether the signal from the thermostat is switched hot or is switched common and adapts the operation of the duct heater control module to the thermostat output signal's protocol for that particular thermostat. The detection hardware and firmware prevent problems of incompatible third-party controllers and thermostats in the field and simplifies the ordering of third-party controllers and thermostats.

In a further aspect of the present invention, the duct heater control module provides a status display of the operation of the duct heater. The most common problem with electric duct heaters is insufficient air flow through the duct heater. Insufficient air flow causes the duct heater control module to deactivate the current switching relays so that the duct heater will not overheat. With conventional duct heater control modules, a service technician has no way to tell if insufficient air flow exists without opening the duct heater and probing with a voltmeter while the power is on. Not only is this diagnostic approach dangerous, but this diagnostic approach is also time consuming for the service technician on site. In order to relay information to the service technician, the microcontroller, in one embodiment of the invention, controls a single green status light emitting diode (LED) that blinks out diagnostic codes. The diagnostic codes are prioritized from critical to informative. This helps the service technician troubleshoot the heater assembly. While a single LED is preferred for providing status information because of its simplicity, other displays including multiple colored LEDs, a digital readout, or graphic displays could be used.

Further objects, features and advantages will become apparent upon consideration of the following detailed description of the invention when taken in conjunction with the drawings and the appended claims.

### BRIEF DESCRIPTION OF THE DRAWINGS

FIG. 1 is a perspective view of a duct heater with a duct heater control module in accordance with the present invention.

FIG. 2 is a plan view of a printed circuit board for a duct heater control module in accordance with the present invention.

FIG. 3 is a overall block diagram of the duct heater control module in accordance with the present invention.

FIG. 4 is a flow chart showing the overall operation of the duct heater control module in accordance with the present invention.

FIG. 5 is a flow chart showing the operation of the air flow sensing and control function of the duct heater control module in accordance with the present invention.

FIG. 6 is a flow chart showing the operation of the relay short cycle sensing and control function of the duct heater control module in accordance with the present invention.

FIG. 7 is an electrical schematic of the circuitry used to detect the control input signal (switched hot or switched common) in accordance with the present invention.

FIG. 8 is a flow chart showing the operation of the display control module of the duct heater control function in accordance with the present invention.

### DETAILED DESCRIPTION OF THE PREFERRED EMBODIMENT

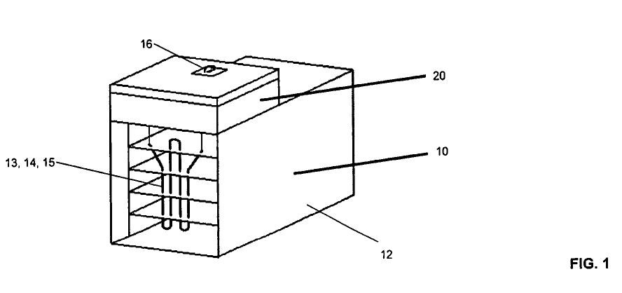

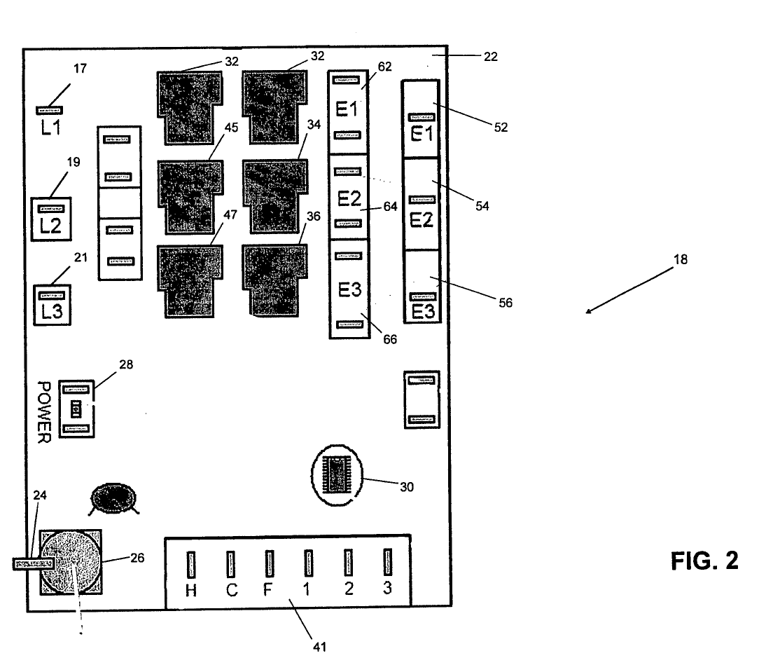

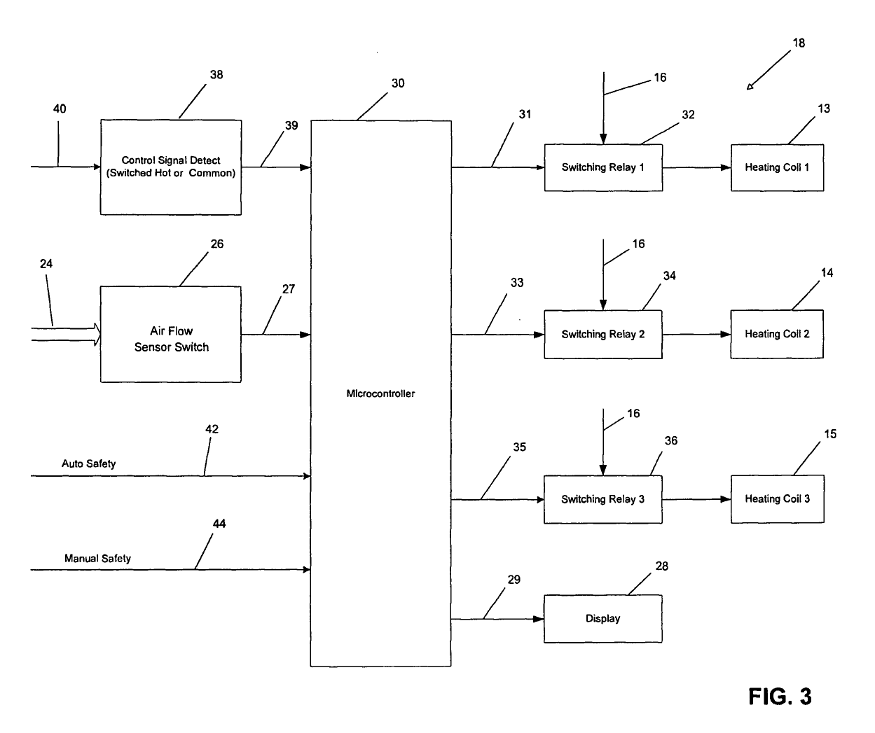

Turning to FIG. 1, a duct heater 10 in accordance with the present invention comprises an enclosure 12, three electric heating elements or coils 13, 14, and 15, and an electrical box 20. While the following description of the present invention contemplates a duct heater 10 with three heating coils 13, 14, and 15, a person of ordinary skill in the art will appreciate that one or more heating coils can be utilized. The electrical box 20 contains the electrical components that control the operation of the duct heater 10 including a duct heater control module 18 (FIGS. 2 and 3). A source of electric current 16 (FIGS. 1 and 3), to energize the heating coils 13, 14, and 15, is connected to the electrical box 20.

Turning to FIG. 2, the duct heater control module 18 includes a 94V-0 listed printed circuit board 22 on which are mounted the various components of the duct heater control module 18 that control the operation of the duct heater 10. The components, mounted on the printed circuit board 22 and interconnected by the printed circuit board 22, include input power taps 17, 19, and 21, switching relays 32, 34, and 36, fan relay 43, manual reset relays 45 and 47, relay DELTA output taps 52, 54, and 56, relay WYE output taps 62, 64, and 66, control signal connector 41, air flow sensor switch 26, microcontroller 30, and LED display 28.

In order to support a full line of duct heaters 10, the duct heater control module 18 needs to support input line voltage inputs of 120 VAC, 208 VAC (1, 2, 3 phase), 240 VAC, 277 VAC, and 480 VAC (1, 2, 3 phase) from the source of electric current 16. These line voltages can be 1-phase, 2-phase, or 3-phase. In order to eliminate the need for a variety of duct heater control modules 18 for each line voltage (and all the related stocking costs), the printed circuit board 22 is configured with input power taps 17, 19, and 21 to accommodate all of the input line voltages for the source of current 16. The input power taps 17, 19, and 21 can accept 1-phase, 2-phase, or 3-phase line voltage. The particular input line voltage can be selected using jumpers (not shown) among the power taps 17, 19, and 21. At the output of the duct heater control module 18, the output power taps (DELTA output taps 52, 53, and 54 and WYE output taps 62, 63, and 64) are labeled to support either DELTA or WYE wiring configurations for the heating coils, 13, 14, and 15. This allows for universal support while simplifying wiring for the factory and/or field technicians.

In order to handle the high switching currents (30 amps or more) present in the electrical box 20 for the duct heater 10, the printed circuit board 22 must have at least 3 ounce copper traces. The 94V-0 rating on the printed circuit board 22 specifies its flammability rating. A 94V-0 material must be self-extinguishing and must not drip or run while burning. Also the flame must go out within 10 seconds. The PCB implemented duct heater control module 18 module is ETL certified.

FIG. 3 shows a functional block diagram of the duct heater control module 18. The heating coils 13, 14, and 15 are connected to and disconnected from the source of electric current 16 by switching relays 32, 34, and 36 respectively. The switching relays 32, 34, and 36 are connected to the heating coils 13, 14, and 15 either by the DELTA outputs 52, 54, in 56 or by the WYE outputs 62, 64, and 66 (FIG. 2). The operation of the switching relays 32, 34, and 36 is controlled by the microcontroller 30 by means of relay outputs 31, 33, and 35 respectively. Based on the logical functions implemented by the microcontroller 30, which will be described in greater detail below, the microcontroller 30 activates and deactivates the switching relays 32, 34, and 36 to energize and de-energize the heating coils 13, 14, and 15. The microcontroller 30 also drives a display 28 by means of a display signal on display signal output 29.

The microcontroller 30 activates and deactivates the switching relays 32, 34, and 36 and controls the display 28 in response to input signals, including input signals on detected control signal output 39, on air flow sensor switch output 27, on automatic safety input 42, and on manual safety input 44. The detected control signal on detected control signal output 39 is generated by the control signal detection circuit 38 that receives a control signal on control signal input 40 from a thermostat or other controller that calls for heat from the duct heater 10. An air flow sensor switch signal on air flow sensor switch output 27 is generated by an air flow sensor switch 26 in response to a pneumatic air flow signal on air flow input 24. The automatic safety signal on automatic safety input 42 results from system sensors that detect alarm conditions such as fan failure, duct overheating, etc. The manual safety signal on manual safety input 44 results from the manual operation of an alarm or panic button.

In order to meet ETL certification, safety overload circuits must be used to shut down the duct heater in certain circumstances. While these safety overload circuits are not part of the control module 18, the automatic safety input 42 is connected to the microcontroller 30 of the control module 18. These safety overload circuits connected to the control module 18 break power to the current switching relays 32, 34, and 36 thereby preventing an unsafe condition.

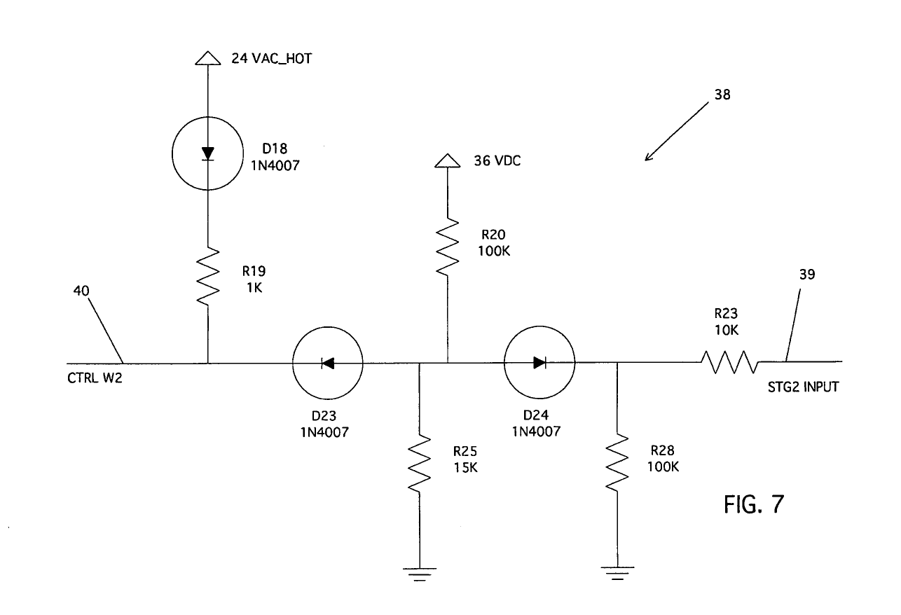

A electrical schematic of the control signal detection circuit 38 is shown in FIG. 7. As previous described, the control signal detection circuit 38 has the control signal input 40 and the detected control signal output 39. A thermostat or other controller (not shown) is connected to the control signal input 40. Again as previously described, third-party controllers or thermostats are generally low voltage, 24 VAC. The thermostat output signals from such thermostats can be either switched hot or switched common. Switched hot and switched common identify the thermostat output signal's protocol. Switched hot means that the current switching relay opens (deactivated) when the 24 VAC thermostat output signal is hot (24 VAC). Switched common means that the current switching relay opens (deactivated) when the 24 VAC thermostat output signal is common (0 VAC). In order to accommodate those separate protocols, the control signal detection circuit 38 in combination with the microcontroller 30 examines the control signal on control signal input 40 to determine whether it is switched hot or switched common and configures the operation of the microcontroller 30 accordingly. Particularly, the control signal detection circuit 38 receives the thermostat control signal on control signal input 40. If the thermostat is a switched hot thermostat, the voltage to deactivate the switching relays 32, 34, and 36 appears as 24 VAC on control signal input 40. If the thermostat is a switched common thermostat, the voltage to deactivate the switching relays 32, 34, and 36 appears as 0 VAC on control signal input 40. The control signal detection circuit 38 generates an analog DC output signal on detected control signal output 39. With no input on control signal input 40, the detected control signal output 39 will be approximately 4.5 VDC. With either a hot or common input on control signal input 40, the detected control signal output 39 will drop somewhere between 0.5 VDC and 1.5 VDC, which can be read and interpreted by the microcontroller 30.

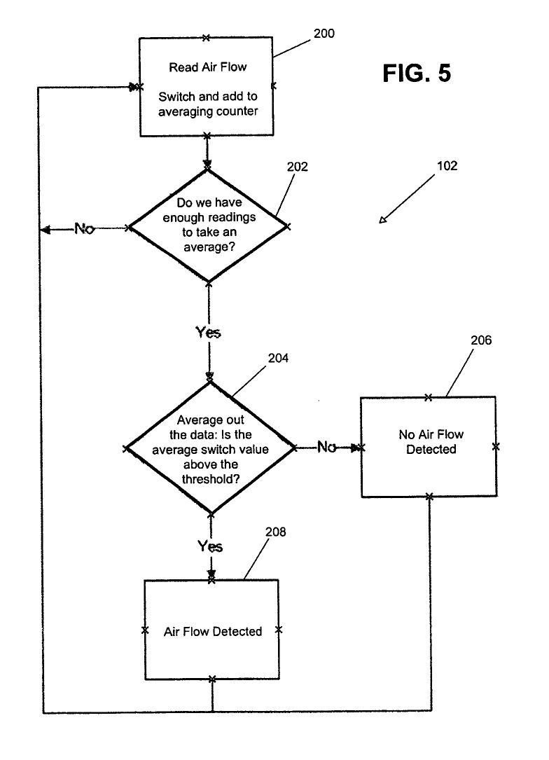

The air flow sensor switch 26 with its pneumatic air flow input 24 and its air flow sensor switch output 27 is a conventional air flow sensor switch such as the Cleveland Controls model DFS-221199 air sensor switch, manufactured and sold by Cleveland Controls, 1111 Brookpark Road, Cleveland, Ohio 44109. In response to changes in the static pressure and velocity pressure within the duct heater 10, the air flow sensor switch 26 produces a logical air flow sensor switch signal on air flow sensor switch output 27. The air flow sensor switch signal changes logical state when the pressure at the air flow input 24 exceeds the trip point of the air flow sensor switch 26. The air flow sensor switch 26 has a trip point at 0.05 inch water column. The trip point of 0.05 inch water column is an extremely low static pressure. When the air flow sensor switch 26 reaches the 0.05 inch trip point, the logical air flow signal on air flow sensor switch output 27 toggles and is sent to the microcontroller 30. Because of the small size of the diaphragm within the air flow sensor switch 26 the diaphragm tends to chatter or pulse in the presence of moving the air within the duct heater 10. In order to assure that each change in logical state of the airflow sensor switch output 27 does not cause the switching relays 32, 34, and 36, to activate and deactivate, the microcontroller 30 has custom firmware to stabilize the air flow signal received from the air flow sensor switch 26. The logical operation of the custom firmware of the microcontroller 30 is illustrated in FIG. 5 and will be described in greater detail below.

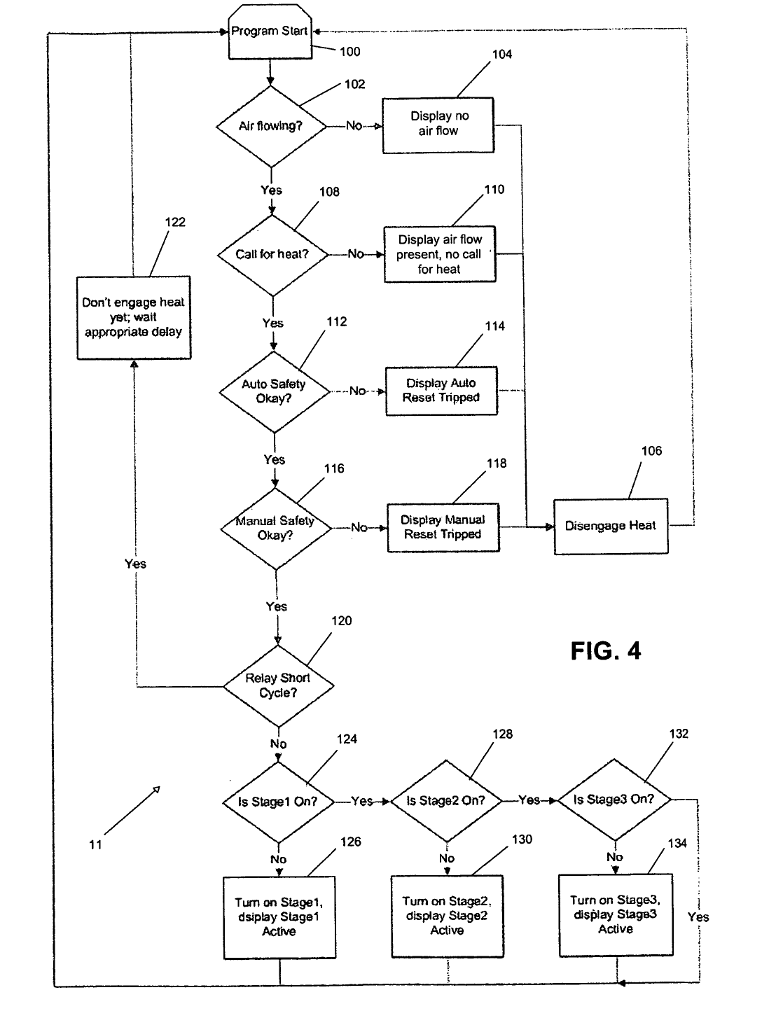

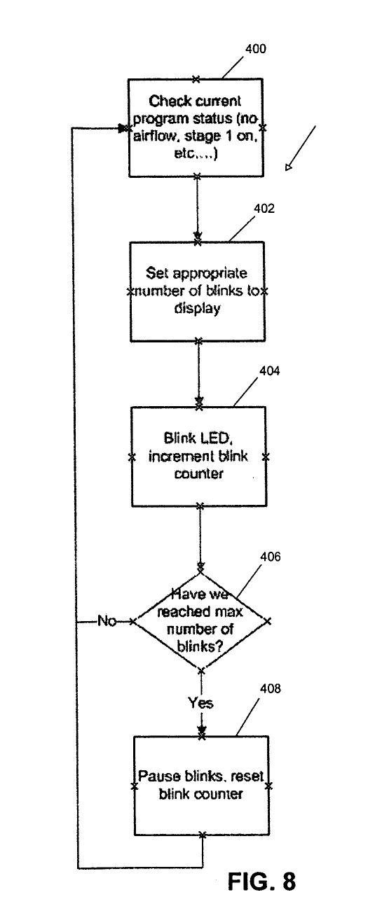

Turning to FIG. 4, the flowchart illustrates the general control process 11 of the duct heater control module 18 implemented by means of the microcontroller 30. The firmware in the microcontroller 30 starts the control process 11 at step 100. At step 102, the microcontroller 30 checks the status of the air flow signal on the air flow sensor switch output 27 (FIG. 3) to determined if air is flowing through the duct heater 10. The determination of air flow at step 102 is made in accordance with the process illustrated in FIG. 5 and described in greater detail below. If air is not flowing in the duct heater 10, the control process 11 moves to step 104, and the microcontroller 30 activates the display signal on the display signal output 29 causing the status display 28 to indicate that air is not flowing in the duct heater 10. The operation of the status display 28 is illustrated in FIG. 8 and will be described in greater detail below. The control process 11 moves from step 104, where the no air flow condition is displayed, to step 106, where the microprocessor 30 deactivates the switching relays 32, 34, and 36 thus disconnecting the flow of current to the heating coils 13, 14, and 15. From step 106, the control process 11 returns to starting step 100.

If at step 102 the microcontroller 30 determines that the air flow is adequate within the duct heater 10, the control process 11 moves from step 102 to step 108. At step 108, the microcontroller 30 checks the status of the control thermostat (not shown) by reading the detected control signal on the detected control signal output 39 (FIG. 3) to determined if the thermostat is calling for heat. If the thermostat is not calling for heat, the control process 11 moves to step 110, and the microcontroller 30 activates the display signal on the display signal output 29 causing the status display 28 to indicate that thermostat is not calling for heat (FIG. 8). The control process 11 moves from step 110, where the no call for heat condition is displayed, to step 106, where the microprocessor 30 deactivates the switching relays 32, 34, and 36 thus disconnecting the flow of current to the heating coils 13, 14, and 15. From step 106, the control process 11 returns to starting step 100.

If at step 108 the microcontroller 30 determines that the thermostat is calling for heat, the control process 11 moves from step 108 to step 112. At step 112, the microcontroller 30 checks the status of the auto safety signal on the auto safety input 42 (FIG. 3) to determined if any system alarms exist that prohibit energizing the heating coils 13, 14, and 15. If the auto safety signal on the auto safety input 42 is not okay (automatic system alarms are present), the control process 11 moves to step 114, and the microcontroller 30 activates the display signal on the display signal output 29 causing the status display 28 to indicate that the auto safety signal is not okay. The control process 11 moves from step 114, where the existence of an automatic alarm safety signal is displayed, to step 106, where the microprocessor 30 deactivates the switching relays 32, 34, and 36 thus disconnecting the flow of current to the heating coils 13, 14, and 15. From step 106, the control process 11 returns to starting step 100.

If at step 112 the microcontroller 30 determines that the auto safety signal is okay (no automatic system alarms present), the control process 11 moves from step 112 to step 116. At step 116, the microcontroller 30 checks the status of the manual safety signal on the manual safety input 44 to determined if any manual alarm exists that prohibit energizing the heating coils 13, 14, and 15. If the manual safety signal on the manual safety input 44 is not okay, the control process 11 moves to step 118, and the microcontroller 30 activates the display signal on the display signal output 29 causing the status display 28 to indicate that the manual safety signal exists. The control process 11 moves from step 118, where the existence of manual alarm safety signal is displayed, to step 106, where the microprocessor 30 deactivates the switching relays 32, 34, and 36 thus disconnecting the flow of current to the heating coils 13, 14, and 15. From step 106, the control process 11 returns to starting step 100.

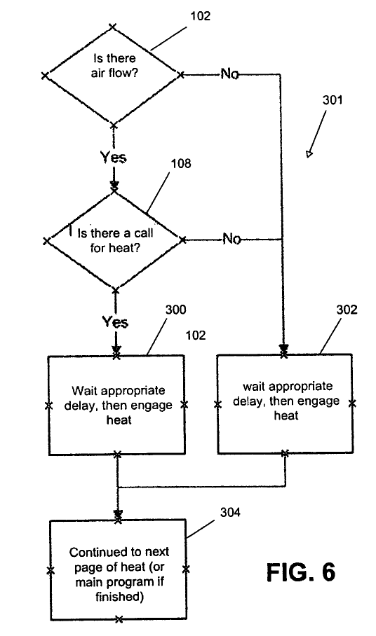

If at step 116 the microcontroller 30 determines that the manual safety signal is okay, the control process 11 moves from step 116 to step 120. At step 116, the microcontroller 30 checks the status of the relay cycling to determined if the switching relays 32, 34, and 36 are rapidly cycling. The determination of rapid relay cycling at step 120 is made in accordance with the process illustrated in FIG. 6 and described in greater detail below. If at step 120, the microcontroller 30 determines that the switching relays 32, 34, and 36 are rapidly cycling, the control process 11 moves to step 122. At step 122, the microcontroller 30 imposes a predetermined delay on the activation of the switching relays 32, 34, and 36. After the predetermined delay at step 122 has expired, the control process 11 returns to the starting step 100.

If at step 120 the microcontroller 30 determines that the switching relays 32, 34, and 36 are not rapidly cycling, the control process 11 moves from step 120 to step 124. At step 124, the microcontroller 30 checks the status of the first switching relay 32 to determine if the first switching relay 32 is active. If at step 124 the microcontroller 30 determines that the first switching relay 32 is not active, the control process 11 moves to step 126. At step 126, the microcontroller 30 activates the first switching relay 32 and simultaneously causes the status display 28 to indicate that the first switching relay 32 is active and therefore the heating coil 13 is energized. From step 126, the control process 11 returns to starting step 100.

If at step 124 the microcontroller 30 determines that the first switching relay 32 is active, the control process 11 moves from step 124 to step 128. At step 128, the microcontroller 30 checks the status of the second switching relay 34 to determine if the second switching relay 34 is active. If at step 128 the microcontroller 30 determines that the second switching relay 34 is not active, the control process 11 moves to step 130. At step 130, the microcontroller 30 activates the second switching relay 34 and simultaneously causes the status display 28 to indicate that the second switching relay 34 is active and therefore the heating coil 14 is energized. From step 130, the control process 11 returns to starting step 100.

If the microcontroller 30 at step 128 determines that the second switching relay 34 is active, the control process 11 moves from step 128 to step 132. At step 132, the microcontroller 30 checks the status of the third switching relay 36 to determine if the third switching relay 36 is activate. If at step 132 the microcontroller 30 determines that the third switching relay 36 is not active, the control process 11 moves to step 134. At step 134, the microcontroller 30 activates the third switching relay 36 and simultaneously causes the status display 28 to indicate that the third switching relay 36 is active and therefore the heating coil 15 is energized. From step 130, the control process 11 returns to starting step 100.

If at step 132 the microcontroller 30 determines that the third switching relay 36 is active, the control process 11 returns to starting step 100.

Turning to FIG. 5, step 102 of the control process 11 is illustrated in greater detail. The air flow sensor switch 26 has a trip point at 0.05 inch water column. The trip point of 0.05 inch water column is an extremely low static pressure. When the air flow sensor switch 26 reaches the 0.05 inch trip point, the air flow sensor switch signal on air flow sensor switch output 27 toggles. Because of the low static pressure trip point and because of the small size of the diaphragm in the air flow sensor switch 26, variations in the air flow within the duct heater 10 cause the air flow sensor switch signal on air flow sensor switch output 27 to pulse. In order to inhibit rapid cycling of the switching relays 32, 34, and 36 in response to the pulsing air flow sensor switch signal, the microcontroller 30 has custom firmware to stabilize the air flow sensor switch signal received from the air flow sensor switch 26. In order to determine whether air is flowing or not in the duct heater 10, the microcontroller 30 receives the air flow sensor switch signal on the air flow sensor switch output 27 from the air flow sensor switch 26. At step 200 (FIG. 5), the microcontroller 30 receives the air flow sensor switch signal and adds the signal to an averaging counter. At step 202 the microcontroller 30 determines whether enough readings of the air flow sensor switch signal have been acquired in order to take an average of the readings. If at step 202 the microcontroller 30 determines that not enough readings have been acquired, based on a predetermined number, the control process 11 returns to step 200, and additional readings of the air flow sensor switch signal are acquired.

If at step 202 the microcontroller 30 determines that enough readings of the air flow sensor switch signal have been acquired, the control process 11 proceeds to step 204 where the microcontroller 30 compares the average of the readings of the air flow sensor switch signal to a predetermined threshold. If at step 204 the average of the readings of the air flow sensor switch signal fall below the predetermined threshold, the control process 11 proceeds to step 206 where the control process 11 determines that there is no air flow (or insufficient air flow) in the duct heater 10. From step, 206 the control process 11 returns to step 200, and the control process 11 continues to monitor the readings from the air flow sensor switch 26. If at step 204 the average of the readings of the air flow sensor switch signal are above the predetermined threshold, the control process 11 proceeds to step 208 where the control process 11 determines that there is sufficient air flow in the duct heater 10. From step 208, the control process 11 returns to step 200, and the control process 11 continues to monitor the readings from the air flow sensor switch 26.

Turning to FIG. 6, illustrates a delay process 301 used in connection with steps 106, 122, 126, 130, and 134 of FIG. 4. The delay process 301 begins by checking the air flow at step 102 of FIG. 4. If no air flow is detected at step 102, the delay process 301 proceeds to step 302, and an appropriate delay is imposed on the deactivation of the switching relays 32, 34, and 36. If air flow is detected at step 102, the delay process 301 proceeds to step 108 of FIG. 4. At step 108, the delay process 301 determines if there is a call for heat. If no call for heat is detected at step 108, the delay process 301 proceeds to step 302, and an appropriate delay is imposed on the deactivation of the switching relays 32, 34, and 36. If a call for heat is detected at step 108, the delay process 301 proceeds to step 300. At step 300, an appropriate delay is imposed on the activation of the switching relays 32, 34, and 36. From step 300 and from step 302, the delay process 301 proceeds to step 304, where the delay process 301 returns to the particular step 106, 122, 126, 130, or 134 of FIG. 4 that called the delay process 301.

As previously described, the microcontroller 30 controls the display 28 by the display signal on the display signal output 29. While the microcontroller 30 can control a number of displays including colored light emitting diodes (LEDs), digital readouts, and graphic displays, the requirements of size and cost for the control module 18 should be considered. In one embodiment of the invention, the microcontroller 30 controls a single light source, particularly, a colored (green) status LED that blinks out diagnostic codes, each code comprising a predetermined number of blinks separated by a pause. The microcontroller 30 generates and prioritizes the diagnostic codes from critical to informative. This helps the service technician troubleshoot the duct heater 10. One possible priority and diagnostic code scheme is illustrated in Table 1 below:

TABLE 1

| Diagnostic Code | |
|---|---|
| (Blink Count) | Duct Heater Status |
| 1 blink | stage 1 heating active (heating coil 13 |
| | energized-step 126) |
| 2 blinks | stage 2 heating active (heating coil 14 |
| | energized-step 130) |
| 3 blinks | stage 3 heating active (heating coil 15 |
| | energized-step 134) |
| 4 blinks | fan only engaged (step 110) |
| 5 blinks | not enough air flow (step 104) |
| 6 blinks | auto reset has tripped (step 114) |
| 7 blinks | manual reset has tripped (step 118) |
| 8 blinks | all OK, no call for heat/fan |

FIG. 8 shows the logical process 401 that the microcontroller 30 uses to drive the single green status LED in the one embodiment where the single green LED constitutes the status display 28. The process 401 begins at step 400 where the microcontroller 30 checks the status of each of the steps 104, 110, 114, 118, 126, 130, and 134 (FIG. 4). If, for example, the microcontroller 30 determines at step 400 that the status of step 104 is that no air is flowing, the process 401 proceeds from step 400 to step 402 where the microcontroller 30 sets the blink count to 5 (not enough air flowing) in accordance with Table 1 above. With the blink count set to 5 at step 402, indicating no air flow, the process 401 proceeds to step 404 where the microcontroller 30 blinks the LED of the status display 28 once and increments a blink counter. At step 406, the microcontroller 30 examines the blink counter to determine if the blink counter has reached the count specified in Table 1 for step 104, namely a blink count of 5. If the blink counter has not reached the predetermined blink count of 5, the process 401 returns to step 400 where the microcontroller 30 checks the status again and recycles. If at step 406 the blink counter has reached the specified count of 5 for step 104, the process 401 proceeds to step 408. At step 408, the microcontroller 30 orders a pause to separate blink codes, resets the blink counter, and the process 401 returns to step 400.

While this invention has been described with reference to preferred embodiments thereof, it is to be understood that variations and modifications can be affected within the spirit and scope of the invention as described herein and as described in the appended claims.

I claim:

1. A duct heater control module for controlling an electric duct heater having a heating element in an air duct comprising:
a. a current switching relay for connecting a source of electric current to and disconnecting the source of electric current from the heating element of the electric duct heater;
b. an air flow sensor switch for sensing air flow within the air duct and producing an air flow signal; and
c. a microcontroller for receiving the air flow signal, stabilizing the air flow signal, and activating and deactivating the switching relay in accordance with the status of the air flow signal.

2. The duct heater control module of claim 1, wherein the microcontroller further:
a. monitors the frequency of the activation and deactivation of the current switching relay; and
b. if the frequency of the activation and deactivation of the switching relay exceeds a threshold, imposing a delay on the next activation the switching relay.

3. The duct heater control module of claim 2, wherein:
a. the duct heater control module further includes an input for receiving a control signal from a thermostat, the control signal having a protocol; and
b. the microcontroller further:
i. determines the protocol of the thermostat control signal; and
ii. configures the duct heater control module to be compatible with the protocol of the thermostat control signal.

4. The duct heater control module of claim 3, wherein:
a. the duct heater control module further includes a display; and
b. the microcontroller further:
i. determines whether the switching relay is activated or deactivated; and
ii. controls the display to indicate whether the switching relay is activated or deactivated.

5. The duct heater control module of claim 4, wherein the display is a single light source, and the microcontroller causes the display to blink a set of diagnostic codes.

6. A duct heater control module for controlling an electric duct heater having a heating element in an air duct comprising:
a. a current switching relay for connecting a source of electric current to and disconnecting the source of electric current from the heating element of the electric duct heater; and
b. a microcontroller for:
i. activating and deactivating the switching relay to connect the source of electric current to and to disconnect the source of current from the heating element of the electric duct heater;
ii. monitoring the frequency of the activation and deactivation of the current switching relay; and
iii. if the frequency of the activation and deactivation of the switching relay exceeds a threshold, imposing a delay on the next activation the switching relay.

7. The duct heater control module of claim 6, wherein:
a. the duct heater control module further includes an input for receiving a control signal from a thermostat, the control signal having a protocol; and
b. the microcontroller further:
i. determines the protocol of the thermostat control signal; and
ii. configures the duct heater control module to be compatible with the protocol of the thermostat control signal.

8. The duct heater control module of claim 7, wherein:
a. the duct heater control module further includes a display; and
b. the microcontroller further:
i. determines whether the switching relay is activated or deactivated; and
ii. controls the display to indicate whether the switching relay is activated or deactivated.

9. The duct heater control module of claim 8, wherein the display is a single light source, and the microcontroller causes the display to blink a set of diagnostic codes.

10. A duct heater control module for controlling an electric duct heater having a heating element in an air duct comprising:
a. a current switching relay for connecting a source of electric current to and disconnecting the source of electric current from the heating element of the electric duct heater;
b. an input for receiving a control signal from a thermostat, the control signal having a protocol; and
c. a microcontroller for:
i. activating and deactivating the switching relay to connect the source of electric current to and to disconnect the source of current from the heating element of the electric duct heater;
ii. determining the protocol of the thermostat control signal; and
iii. configuring the duct heater control module to be compatible with the protocol of the thermostat control signal.

11. The duct heater control module of claim 10, wherein:
a. the duct heater control module further includes a display; and
b. the microcontroller further:
i. determines whether the switching relay is activated or deactivated; and
ii. controls the display to indicate whether the switching relay is activated or deactivated.

12. The duct heater control module of claim 11, wherein the display is a single light source, and the microcontroller causes the display to blink a set of diagnostic codes.

13. A duct heater control module for controlling an electric duct heater having a heating element in an air duct comprising:
a. a current switching relay for connecting a source of electric current to and disconnecting the source of electric current from the heating element of the electric duct heater;
b. a display; and
c. a microcontroller for:
i. activating and deactivating the switching relay to connect the source of electric current to and to disconnect the source of current from the heating element of the electric duct heater;
ii. determining whether the switching relay is activated or deactivated; and
iii. controlling the display to indicate whether the switching relay is activated or deactivated.

14. The duct heater control module of claim 13, wherein the display is a single light source, and the microcontroller causes the display to blink a set of diagnostic codes.
